(19) United States
(12) Patent Application Publication
(10) Pub. No.: US 2005/0078437 A1
(43) Pub. Date: Apr. 14, 2005

(54) Variable chassis for interface card modules

(75) Inventors: Chia-Ming Chuang, Taipei City (TW); Chun-Hsien Lin, Pan-Chiao City (TW)

Correspondence Address: LINIAK, BERENATO & WHITE, SUITE 240, 6550 ROCK SPRING DRIVE, BETHESDA, MD, 20817-1132, US

(73) Assignee: CHROMA ATE INC.

(21) Appl. No.: 10/920,258

(22) Filed: Aug. 18, 2004

(30) Foreign Application Priority Data
Aug. 19, 2003 (TW) 092214996

(51) Int. Cl. G06F 13/14

(52) U.S. Cl. 361/600

(57) ABSTRACT

A chassis for interface card modules includes a housing and a pair of parallel first rails disposed within the housing. A second rail is disposed between and in parallel to the first rails. A plurality of card guides are mounted detachably on the first and second rails. The second rail includes a main rail section and an extension rail section which are interconnected releaseably by a fastening unit. A partition plate has two opposite ends connected respectively and detachably to the first rails. The extension rail section is connected detachably to the partition plate. The partition plate is changeable in position on the first rails. The total length of the second rail is changeable due to the presence of the extension rail section.

### CROSS-REFERENCE TO RELATED APPLICATION

This application claims priority of Taiwanese Utility Application No. 92214996 filed on Aug. 19, 2003.

### BACKGROUND OF THE INVENTION

1. Field of the Invention

This invention relates to a chassis for holding interface cards, more particularly to a chassis for interface card modules such as those having PXI, cPCI and VXI specifications.

2. Description of the Related Art

Instruments having interface cards of VXI, cPCI (compact PCI), PXI (PCI extensions instrumentation) specifications are commonly used in testing and measuring systems, industrial automation, and data acquisition. These instruments are of high efficiency and stable instruments which can perform effectively their functions, such as weather observation and survey, and telecommunication for automobiles, aircrafts etc., even in an unfavorable environment and under unstable power supply. These instruments have the advantages of low costs and high speed data acquisition.

Such instruments usually include chassises which are designed and fabricated for particular card specifications and for a particular number of cards. For instance, cards having the compact CPI and PXI specifications are provided with two card sizes, referred to as 3U and 6U. In general, a 6U chassis is used for the 6U card size, whereas a 3U chassis is used for the 3U card size. For improvements in such chassis systems, it has been suggested that a 6U chassis be provided with a partition plate so that the 6U chassis is divided into two regions for the installation of cards having the 3U card size.

Nevertheless, the conventional chassises are usually fabricated with customized specifications. Thus, once a chassis is fabricated, it is difficult to change the dimensions or arrangement of the interior space in the chassis so that the type or the number of the cards that can be installed in the chassis can not be varied. Therefore, there is a need for an instrument of the above-mentioned type provided with a chassis whose interior spatial arrangement is easily changeable.

### SUMMARY OF THE INVENTION

The object of the present invention is to provide an instrument of the above-mentioned type with a chassis system that is variable in interior dimensions or arrangement so as to accommodate different numbers of interface card modules having different card sizes.

According to the present invention, a chassis for holding interface card modules comprises: a housing which includes a top side, a bottom side, and first and second lateral sides interconnecting the top and bottom sides. A pair of first rails are disposed respectively on the top and bottom sides and have opposing faces which are formed with a plurality of first engaging slots. A partition plate has a top end connected detachably to a selected one of the first engaging slots of one of the first rails mounted on the top side and a bottom end connected detachably to a selected one of the first engaging slots of the other one of the first rails mounted on the bottom side. The partition plate is changeable in position to vary the distance of the partition plate from the first and second lateral sides. A second rail is disposed between and substantially in parallel with the first rails. The second rail has a plurality of second engaging slots. A plurality of card guides are mounted on each of the first and second rails through the first or second engaging slots. Each of the card guides has a slide channel adapted to receive a card edge of one of the interface card modules. The second rail includes a main rail section an extension rail section, and a fastening unit interconnecting releaseably the main and extension rail sections. Each of the main and extension rail sections has two longitudinally opposed first and second end faces. The first end face of the main rail section is attached to one of the first and second lateral sides. The first end face of the extension rail section is attached to the partition plate. The second end faces of the main and extension rail sections abut against each other. The fastening unit fastens together the second end faces of the main and extension rail sections.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a front view of a preferred embodiment of the chassis according to the present invention;

FIG. 2 is a fragmentary plan view of the preferred embodiment;

FIG. 3 is a perspective view showing first and second rails of the preferred embodiment;

FIG. 4 is an exploded view showing main and extension rail sections of the second rail;

FIG. 5 is a perspective view of a card guide used in the preferred embodiment; and

FIG. 6 is a perspective view showing a partition plate and auxiliary plates used in the preferred embodiment.

### DETAILED DESCRIPTION OF THE PREFERRED EMBODIMENT

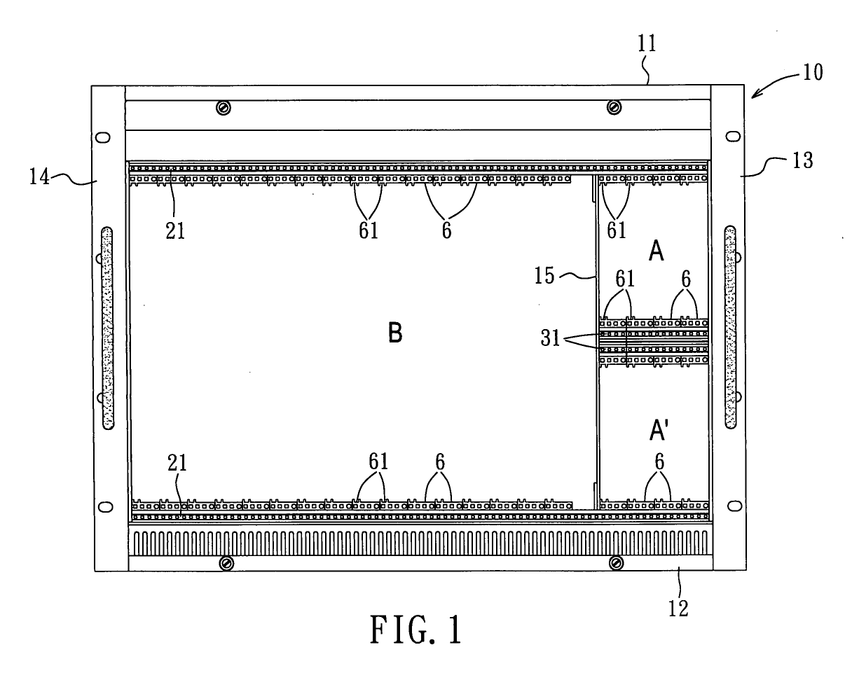

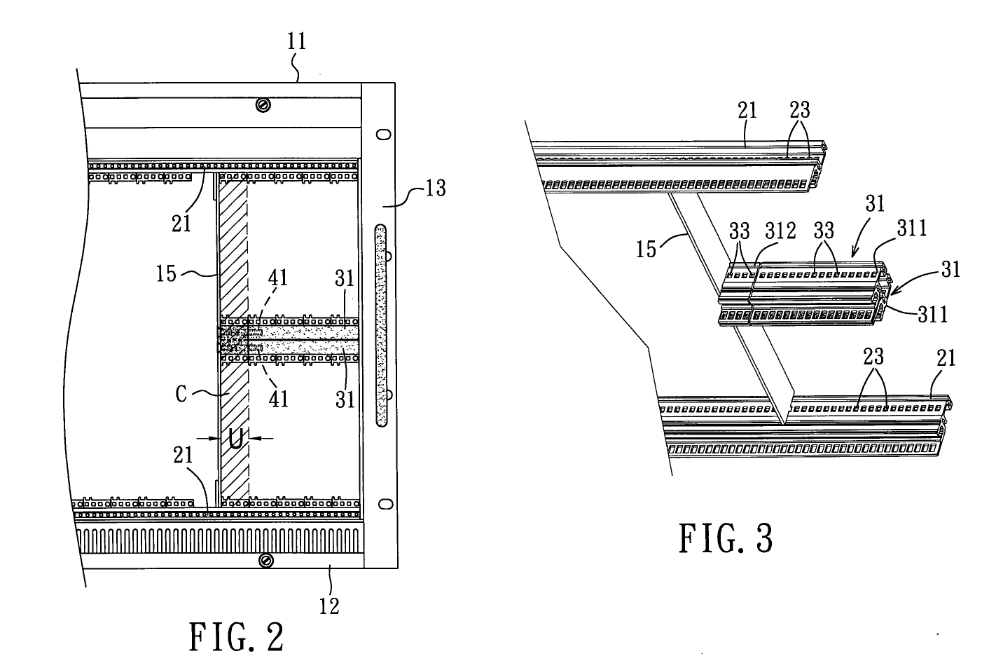

Referring to FIGS. 1, 2, 3 and 4, a chassis embodying the present invention is shown to include a housing 10 which has a top side 11, a bottom side 12, and first and second lateral sides 13, 14 interconnecting the top and bottom sides 11 and 12.

A pair of first rails 21 are disposed respectively on the top and bottom sides 11, 12. The first rails 21 are substantially parallel to each other and have opposing faces both of which are formed with a plurality of first engaging slots 23.

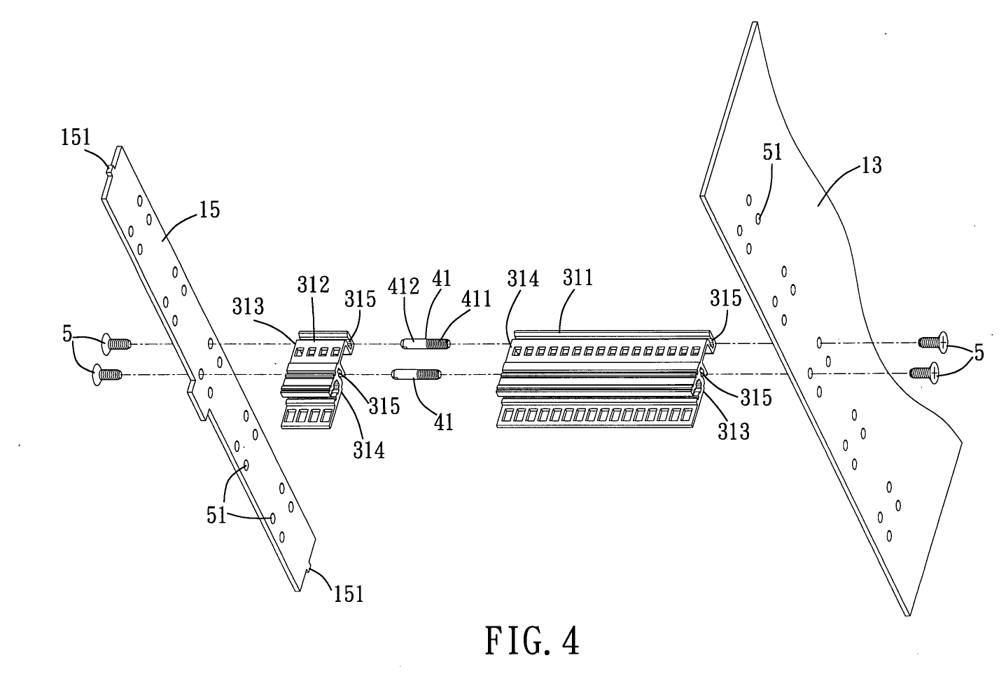

A vertical partition plate 15 is provided between the first rails 21 and has top and bottom ends each of which has a protrusion 151 engaging releaseably a selected one of the first engaging slots 23 of one of the first rails 21. The protrusion 151 may be one which projects directly from the top or bottom end of the partition plate 15, as shown in FIG. 4, or one which is formed on an auxiliary plate 152 that is secured to the top or bottom end of the partition plate 15 by means of screws 153, as shown in FIG. 6.

With the partition plate 15, the interior space of the housing 10 is divided into more than one region. The distance of the partition plate 15 from the first and second lateral sides 13 and 14 may be varied by changing the position of the partition plate 15 from one of the first engaging slots 23 to the other first engaging slot 23.

Two second rails 31 are arranged in a stack and are disposed between and in parallel to the first rails 21. Each second rail 31 is composed of a main rail section 311 and an extension rail section 312 both of which have a plurality of second engaging slots 33. According to the present invention, the extension rail section 312 is provided with varying lengths so as to add different extension lengths to the main rail section 311 or to vary the total length of each second rail 31. Preferably, the length of the extension rail section 312 is a multiple of a width “U” of an interface card module (C).

The main rail section 311 and the extension rail section 312 are interconnected releaseably by means of a fastening unit. The fastening unit in this embodiment includes a pair of screw elements 41 that interconnect the main and extension rail sections 311 and 312. Specifically, each of the main and extension rail sections 311 and 312 has two longitudinally opposed first and second end faces 313 and 314. The first end faces 313 of the main and extension rail sections 311, 312 are attached respectively to the first lateral side 13 and the partition plate 15 by using attachment screws 5 which extend through four holes 51 provided in each of the first lateral side 13 and the partition plate 15. A plurality of sets of the holes 51 are provided in the first lateral side 13 and the partition plate 15 so that the main and extension rail sections 311 and 312 may be positioned at a desired height by selecting a suitable set of the holes 51. The second end faces 314 of the main and extension rail sections 311, 312 abut against each other and are interconnected releaseably by the screw elements 41.

Each screw element 41 has a threaded section 411 threadedly inserted into grooves 315 from the second end face 314 of the main rail section 311, and a non-threaded section 412 inserted into the grooves 315 from the second end face 314 of the extension rail section 312.

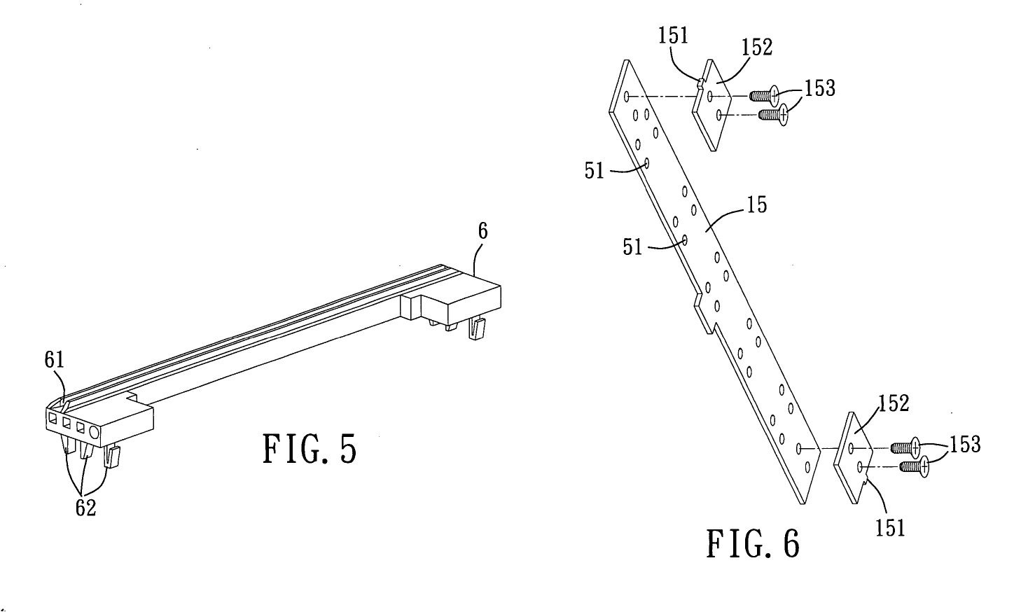

A plurality of card guides 6 are mounted on each first rail 21 through the first engaging slots 23 and are mounted on the main and extension rail sections 311 and 312 of each second rail 31 through the second engaging slots 33. As shown in FIG. 5, each card guide 6 has a slide channel 61 along which a card edge (not shown) of the interface card module (C) can be slid, and retention elements 62 for releasable engagement with the first or second engaging slots 23 or 33. The slide channels 61 of the card guides 6 on the first rail 21 disposed on the top side 11 are aligned respectively with the slide channels 61 of the card guides 6 on the first rail 21 disposed on the bottom side 12.

Referring once again to FIG. 1, due to the presence of the partition plate 15 and the second rails 31, the housing 10 is divided into regions A, A′ and B. The region B is suitable for the installation of 6U size cards, whereas the regions A and A′ are useful for the installation of 3U size cards. Therefore, the chassis according to the present invention can accommodate interface cards of 6U and 3U card sizes.

Unlike the present invention, in the conventional 6U chassis, if twenty one pairs of card guides are disposed on two parallel rails, twenty one 6U size cards can be assembled within the conventional chassis. The only change that has been made in the conventional chassis is to use a horizontal partition to divide the conventional 6U chassis into upper and lower regions and to assemble twenty one 3U size cards in each of the upper and lower regions.

In the present invention, the partition plate 15 may be detached from the first rails 21 by disengaging the protrusions 151 from the corresponding first engaging slots 23 and by re-attaching the same to the other engaging slots 23 to change the position of the partition plate 15 and to vary the dimensions of the regions A, A′ and B. The extension rail sections 312 of the two second rails 31 provide an additional space for installing an added amount of the card guides 6 so that a greater number of 3U size cards can be installed in the regions A and A′.

In order to match the dimensions of the region A and A′, the total length of each second rail 31 can be changed by removing the existing extension rail section 312 from the main rail section 311 or by replacing the existing extension rail section 312 with a new one having a different length. The replacement of the extension rail section 312 can be conducted by first detaching each second rail 31 from the partition plate 15 and the first lateral side 13 and then separating the main and extension rail sections 311 and 312 from each other.

As mentioned above, the chassis for holding interface card modules according to the present invention has interior components which can be disassembled and re-assembled easily. Thus, the interior arrangement of the chassis can be varied easily by the users themselves to fit different numbers of 6U and 3U size cards.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A chassis for holding interface card modules, comprising:
a housing;
a first rail and a second rail disposed in parallel within said housing, said first and second rails being spaced apart from each other and having opposing faces; and
a plurality of card guides mounted on said opposing faces of said first and second rails and respectively having slide channels each of which is adapted to receive a card edge of one of the interface card modules,
wherein said second rail includes a main rail section, an extension rail section, and a fastening unit interconnecting releaseably said main and extension rail sections, each of said main and extension rail sections having two longitudinally opposed first and second end faces, said first end faces of said main and extension rail sections being fixed to said housing, said second end faces of said main and extension rail sections abutting against each other, said fastening unit fastening together said second end faces of said main and extension rail sections.

2. The chassis as claimed in claim 1, wherein said fastening unit includes a screw element which has a threaded section threadedly inserted into one of said second end faces, and a non-threaded section inserted into the other one of said second end faces.

3. The chassis as claimed in claim 1, wherein both of said main and extension rail sections are connected to some of said card guides.

4. A chassis for holding interface card modules, comprising:
a housing having a top side, a bottom side, and first and second lateral sides interconnecting said top and bottom sides;
a pair of first rails mounted within said housing and disposed respectively on said top and bottom sides, said first rails having opposing faces each of which is formed with a plurality of first engaging slots; and
a plurality of card guides mounted on said opposing faces of said first rails through said first engaging slots and respectively having slide channels each of which is adapted to receive a card edge of one of the interface card modules; and
a partition plate dividing said housing into more than one region and having top and bottom ends each of which is connected detachably to a selected one of said first engaging slots, whereby said partition plate is changeable in position relative to said first rails to vary a dimension of said region.

5. The chassis as claimed in claim 4, wherein each of said top and bottom ends has a protrusion engaging releaseably one of said first engaging slots.

6. The chassis as claimed in claim 4, further comprising a second rail disposed between said first rails and having two opposite ends connected respectively to said partition plate and one of said first and second lateral sides.

7. A chassis for holding interface card modules, comprising:
a housing including a top side, a bottom side, and first and second lateral sides interconnecting said top and bottom sides;
a pair of first rails disposed respectively on said top and bottom sides and having opposing faces which are formed with a plurality of first engaging slots;
a partition plate having a top end connected detachably to a selected one of said first engaging slots of one of said first rails mounted on said top side and a bottom end connected detachably to a selected one of said first engaging slots of the other one of said first rails mounted on said bottom side, said partition plate being changeable in position to vary the distance of said partition plate from said first and second lateral sides;
a second rail disposed between and substantially in parallel with said first rails, said second rail having a plurality of second engaging slots; and
a plurality of card guides mounted on each of said first and second rails through said first or second engaging slots, each of said card guides having a slide channel adapted to receive a card edge of one of the interface card modules,
wherein said second rail includes a main rail section, an extension rail section, and a fastening unit interconnecting releaseably said main and extension rail sections, each of said main and extension rail sections having two longitudinally opposed first and second end faces, said first end face of said main rail section being attached to one of said first and second lateral sides, said first end face of said extension rail section being attached to said partition plate, said second end faces of said main and extension rail sections abutting against each other, said fastening unit fastening together said second end faces of said main and extension rail sections.

8. The chassis as claimed in claim 7, wherein said fastening unit includes a screw element which has a threaded section threadedly inserted into one of said second end faces, and a non-threaded section inserted into the other one of said second end faces.

9. The chassis as claimed in claim 7, which has a compact PCI specification.

10. The chassis as claimed in claim 7, which has a PXI specification.

11. The chassis as claimed in claim 7, which has a VXI specification.

12. The chassis as claimed in claim 7, wherein said extension rail section has a length which is substantially a multiple of the width of one of the interface card modules.

13. The chassis as claimed in claim 7, wherein each of said top and bottom ends has a protrusion engaging releaseably one of said first engaging slots.

14. The chassis as claimed in claim 7, wherein both of said main and extension rail sections are connected to some of said card guides.
